(19) United States
(12) Patent Application Publication
(10) Pub. No.: US 2008/0285571 A1
(43) Pub. Date: Nov. 20, 2008

(54) Media Data Processing Using Distinct Elements for Streaming and Control Processes

(76) Inventors: Ambalavanar Arulambalam, Macungie, PA (US); Jian-Guo Chen, Basking Ridge, NJ (US); Nevin C. Heintze, Bethlehem, PA (US); Hakan I. Pekcan, Basking Ridge, NJ (US); Kent E. Wires, Mine Hill, NJ (US)

Correspondence Address: DUANE MORRIS LLP - Philadelphia;IP DEPARTMENT, 30 SOUTH 17TH STREET, PHILADELPHIA, PA, 19103-4196, US

(21) Appl. No.: 12/089,509

(22) PCT Filed: Oct. 6, 2006
(86) PCT No.: PCT/US06/39223

§ 371 Date: Apr. 7, 2008

Related U.S. Application Data
(60) Provisional application No. 60/724,462, filed on Oct. 7, 2005.
(60) Provisional application No. 60/724,463, filed on Oct. 7, 2005.
(60) Provisional application No. 60/724,464, filed on Oct. 7, 2005.
(60) Provisional application No. 60/724,722, filed on Oct. 7, 2005.
(60) Provisional application No. 60/725,060, filed on Oct. 7, 2005.
(60) Provisional application No. 60/724,573, filed on Oct. 7, 2005.

(51) Int. Cl. H04L 12/56

(52) U.S. Cl. 370/400

(57) ABSTRACT

A hardware accelerated streaming arrangement, especially for RTP real time protocol streaming, directs data packets for one or more streams between sources and destinations, using addressing and handling criteria that are determined in part from control packets and are used to alter or supplement headers associated with the stream content packets. A programmed control processor responds to control packets in RTCP or RTSP format, whereby the handling or direction of RTP packets can be changed. The control processor stores data for the new addressing and handling criteria in a memory accessible to a hardware accelerator, arranged to store the criteria for multiple ongoing streams at the same time. When a content packet is received, its addressing and handling criteria are found in the memory and applied, by action of the network accelerator, without the need for computation by the control processor. The network accelerator operates repetitively to continue to apply the criteria to the packets for a given stream as the stream continues, and can operate as a high date rate pipeline. The processor can be programmed to revise the criteria in a versatile manner, including using extensive computation if necessary, because the processor is relieved of repetitive processing duties accomplished by the network accelerator.

### CROSS-REFERENCE TO RELATED APPLICATIONS

This application claims the benefit of U.S. provisional patent application Nos. 60/724,462, filed Oct. 7, 2005; 60/724,463, filed Oct. 7, 2005; 60/724,464, filed Oct. 7, 2005; 60/724,722, filed Oct. 7, 2005, 60/725,060, filed Oct. 7, 2005; and 60/724,573, filed Oct. 7, 2005; all of which applications are expressly incorporated by reference herein in their entireties.

### BACKGROUND OF THE INVENTION

The invention concerns real time data transport apparatus and methods, for example in a digital video processing center or an entertainment system, conferencing system or other application using RTP streaming. The invention also is generally applicable to packet data transport applications wherein transport couplings between sources and destinations are started, stopped and changed from time to time according to the programming of a control processor.

The inventive apparatus and methods serve various recording, playback and processing functions wherein content and control information is directed to and from functional elements that store, present or process data. According to an inventive aspect, repetitive data processing transport functions that are particularly demanding with respect to data rate but are not computationally complex, for example repetitive routing of data packets to and from network attached storage elements, are handled separately from functions, such as control processing and addressing steps, that are computationally complex but also are relatively infrequent. In a preferred arrangement, accelerators that comprise hardware devices are provided in data communication with control processors and network attached data storage devices. The accelerators are substantially devoted to transport functions, thereby achieving high data throughput rates while freeing processors to handle control functions according to programming that can respond in versatile and optimized ways to changing demands.

It is advantageous in general to enable potentially different devices using potentially different data formats to interact. Design challenges are raised by the need to provide versatility in data processing systems, while accommodating different devices and data formats at high data rates.

Industry standards govern the formatting of certain data types. Standards affect addressing and signaling techniques, data storage and retrieval, communications, etc. Standards typically apply at multiple levels. For example, a packet signaling standard or protocol may apply when transporting video data that is encoded according to a video encoding standard, and so forth.

Packet data transported between a source and destination may advantageously be subjected to intermediate processing steps such as data format conversions, computations, buffering, and similar processing and/or storage steps. In a data processing system that has multiple servers and terminal devices, part of the computational load is directed to activities associated with data formatting and reformatting. Part of the load is addressing and switching between data sources and destinations, potentially changing arrangements in response to conditions such as user selections.

Some of the data processing and communications functions that are applicable are repetitive operations in which sequential data packets are processed in much the same way for transport from a source to a destination. These functions can benefit from streamlining and simplifying a data pipeline configuration, to maximize speed.

Other data processing and communications functions are likely to be more managerial and computationally intensive. For example, when reconfiguring a data flow path to add, remove or switch between source and destination nodes or to change between functions, a control processor might be programmed to invoke various other steps besides repetitively adjusting addresses and the like for one packet after another. These functions can benefit from versatility, and that implies programming and computational complexity.

The objects of streamlining and simplifying for speed, versus providing computational complexity, of course are inconsistent design objectives. It would be advantageous to optimize the concurrent need for speed and data capacity, versus the need for computational power, so as to provide arrangements that are both fast and versatile. The present invention subdivides certain functions needed for data transport, into groupings. Relatively simple high speed and typically repetitive functions are assigned to an accelerator element that can be embodied wholly or partly in hardware, i.e., a hardware network accelerator. Relatively complex and adaptive computational functions are assigned to a control processor and are substantially embodied by software. Among its functions, the control processor sets up and stores conditions and factors into the hardware network accelerator, such addressing information that is to be used repetitively during a particular operation involving transport of successive packets.

In a preferred embodiment, the invention is demonstrated with respect to real time protocol (RTP) packet streaming. An exemplary group of packet source and destination types are discussed, applicable to video data processing for entertainment or teleconferencing, but potentially including security monitoring, gaming systems, and other uses. The transport paths may be wired or wireless, and may involve enterprise or public networks. The terminals for playback may comprise audio and video entertainment systems, computer workstations, fixed or portable devices. The data may be stored and processed using network servers. Exemplary communications systems include local and wide area networks, cable and telecommunications company networks, etc.

In connection with audio and video data, the Real Time Protocol (“RTP,” also known as the “Real Time Transport Protocol”) is a standard protocol that is apt for moving packetized audio and/or image and moving image data over data communication networks, at a real time data rate. Playback of audio and video data at a real time or live rate is desirable to minimize the need for storage buffers, while avoiding stopping and starting of the content. In applications such as teleconferencing and similar communications, the collection, processing, transport and readout of packetized data advantageously should occur with barely perceptible delays and no gaps, consistent with face-to-face real time conferences and conversations.

The RTP Real Time Protocol is a known protocol intended to facilitate handling of real-time data, including audio and video, in a streamlined way. It can be used for media-on-demand as well as interactive services such as Internet telephony. It can be used to direct audio and video to and from multiple sources and destinations, to enable presentation and/or recording together with concurrent processing.

The manner in which the data are handled is changeable from time to time, using control and addressing functions, for example to initiate and end connections involving particular sources, destinations or participants. Thus, RTP contains a data content part for transport of content, and a control part for varying the manner of data handling, including starting, stopping and addressing. The control part of RTP is called “RTCP” for Real Time Control Protocol.

The data part of RTP is a thin or streamlined protocol that provides support for applications with real-time properties such as the transport of continuous media (e.g., audio and video). This support includes timing reconstruction, loss detection or recovery, security, content identification and similar functions that are repetitive and occur substantially continuously with transport of the media content.

RTCP provides support for real-time conferencing of groups of any size within a communication network such as the Internet. This support includes source identification and support for gateways like audio and video bridges as well as multicast-to-unicast translators. It offers quality-of-service feedback from receivers to the multicast group as well as support for the synchronization of different media streams.

RTP and RTCP are data protocols that are particularly arranged to facilitate transport of data of the type discussed above, but in a given network configuration the RTP and RTCP protocols might be associated with higher or lower protocols and standards. On a higher level, for example, the RTP and RTCP protocols might be used to serve a video conferencing system or a view-and-store or other technique for dealing with data. On a lower or more basic level, the packets that are used in the RTP and RTCP data transport might actually be transmitted according to different packet transmission message protocols. Examples are Transmission Control Protocol (TCP or on the Internet, TCP/IP) and User Datagram Protocol (UDP).

The TCP and UDP protocols both are for packet transmission but they have substantially different characteristics regarding packet integrity and error checking, sensitivity to lost packets and other aspects. TCP generally uses aspects of the protocol to help ensure that a two way connection is maintained during a transmission and that the connection remains until all the associated packets are transmitted and assembled at the receiving end, possibly including re-tries to obtain packets that are missing or damaged. UDP generally handles packet transmission attempts, but it is up to the applications that send and receive the packets to ensure that all the necessary packets are sent and received. Some applications, such as streaming of teleconferencing images, are not highly sensitive to packets being intermittently dropped. But it is advantageous if packets should be dropped, that the streaming continue as seamlessly as possible.

It would be advantageous if techniques could be worked out wherein real time transmission is operable using a wide range of higher and lower protocols, while permitting the configuration to take full advantage of the ways in which the different protocols differ. It would be particularly useful in high performance or high demand systems to tailor the operation so that the resources available for communication and the resources available for computations and situation sensitive switching and decision making could be optimized.

### SUMMARY

It is an aspect of the invention to provide for efficient video and similarly continuous stream data processing, by employing data processing arrangements having distinct and contemporaneously operating transport data paths and control data paths, wherein the two data paths separately handle data-throughput intensive functions, and data-processing intensive functions, using distinct cooperating resources that separately are configured for throughput and processing power, respectively.

More particularly a method and apparatus are provided for facilitating and accelerating the processes conducted by a media server by partitioning subsets of certain resource-intensive processes associated with the real time protocol (RTP), for handling by processors and switching devices that are optimized for their assigned subsets. Partitioning of functions based on speed are assigned to devices that have the characteristics of data pipelines. The computational load is assigned to one or more central processors that govern the RTP sessions and handle the computational side with less processor attention paid to moving the streaming data in the data communication pipeline.

In certain embodiments, the method concerns using a hardware interface element repetitively to replace header data found in selected packets that are sent or received under control of a central processor. The central processor may establish criteria, such as arranging for packets having certain identifying attributes to handled in a certain way, such as routed to a particular address. This criteria is stored by the central processor so as to control the hardware interface element. The hardware element imposes the results on the transport data, including by substituting header data values found each successive packet header with received date read our from or generated as a result of data originating from the controlling processor.

The hardware interface element can operate at high data rates without substantial supervision, controlling the streaming of RTP packets to or from destinations and sources such as audiovisual presentation devices and network attached storage devices. In this way the hardware interface element accelerates handling of the data, while freeing the controlling processor for attention to functions that are more computationally intensive than IF/THEN replacement of certain header values with defined substitute values, now accomplished by the hardware accelerator.

In a data streaming communication arrangement based on transmission of addressed data packets, whether the arrangement involves a local or wide area network, the same data paths that carry the data packets associated with repetitive streaming functions also carry the control and addressing packets associated with computationally demanding functions needed for managing the data streaming. According to an aspect of the invention, a content addressable memory (CAM) file is maintained by which a hardware accelerator associates multiple presently-maintained packet queues with certain addresses. When a SETUP request is received to initiate a new streaming connection to a new endpoint, no matching entry is found in the CAM file. The hardware accelerator is provided with associated header values, namely by initiating an entry in the content addressable memory (CAM) in anticipation of a RECORD or SEND message. The header values associated with the new endpoint are known to the control processor but the processor need only establish the routing to the new endpoint by setting up a new packet queue in the content addressable memory (CAM). The hardware accelerator can then operate as an automaton that finds the packet queue entries for an incoming packet, substitutes the necessary values, and passes the packet on toward its destination.

When an RTSP RECORD or SEND message is received that has an established queue entry, responsibility for determining the outgoing header values is on the hardware accelerator, in data communication with the traffic manager and the central processor. The connection can remain under way and with the benefit of a high data rate until completed or until the central processor effects necessary new controls and activities such as determining the endpoint or endpoints of the stream according to any of the programmable functions. Such functions can include many or all of the functions that otherwise would require a controller to decide via programmed software routines how to deal with each passing packet. Such functions can include routing of packets between sources and destinations, inserting intermediate processing steps, routing packets to two or more destinations at the same time, such as to record while playing, and so forth.

The content addressable memory technique of replacing particular header values with stored values is relatively mechanical and can be accomplished quickly. Some RTP control functions, such as RTP termination routines for example, may be somewhat complex an not optimally handled in hardware, for example because there are plural packets involved and not a one for one exchange, or perhaps because conditional steps are involved that are more complex than IF/THEN replacements based on stored values.

On the other hand, streaming throughput demands may be strict. In order to meet the throughput in a conventional way, a very fast and capable central processor may be needed to discharge both computation loads and also header value substitutions on the fly. It is an inventive aspect to employ the hardware accelerator to handle the header value substitutions after the central processor provides the substitution values and criteria.

Once packet queue entries are established, each packet on the stream is applied initially to the network accelerator, i.e., the high speed unit implemented substantially in hardware. The accelerator matches the packet to information in the content addressable memory CAM connection table, strips the layer three and four headers (for example), and inserts a new local header. The packet that now contains a potentially altered local header, RTP header and RTP payload, is sent through the traffic manager to its destination, e.g., to be written to an addressed disk in a RECORD operation, to be sent to a presentation device or to some other address in a PLAY operation, to do two or more such operations at once, etc.

An advantage of the inventive method is that incoming RTP traffic can be handled, and can ultimately be controlled by software. If new and different RTP payload types should become popular or if the definitions of know payload types should change, support for them can be maintained by the streamer. In addition, the highly desirable function in personal video recording (PVR) of delayed-view-while-recording can be supported very efficiently.

A disadvantage of the inventive technique is that storing the object in the RTP local-header format may make the object inaccessible for HTTP transfers or in some situations may require operations to undo the effects. However, appropriate software routines on the host processor can be used to reassemble the original media object, either promptly in order to make the object available immediately to non-RTP clients, or at some future time when resources are available and/or a demand for the object arises.

These and other objects and aspects will become apparent in the following discussion of preferred embodiments and examples.

### BRIEF DESCRIPTION OF THE DRAWINGS

There are shown in the drawings certain exemplary and nonlimiting embodiments of the invention as presently preferred. Reference should be made to the appended claims, however, in order to determine the scope of the invention in which exclusive rights are claimed. In the drawings,

FIG. 1 is a block diagram illustrating a source-to-destination data transport relationship (e.g., server to client), according to the invention, wherein the RTP data content component is routed around a control point, such as a central processor that handles RTSP and/or RTCP control signaling.

FIG. 2 is a block diagram showing a streaming controller according to the invention.

FIG. 3 is a table showing the component values in an RTP header.

FIG. 4 is a data table diagram illustrating pre-appending an RTP header with a local address header.

FIG. 5 is a block diagram showing the data flow and data components involved in using a content addressable memory to repetitively apply values obtained initially from a central processor.

FIG. 6 is a logical flow chart showing the functions carried out in setting up and carrying on a data streaming connection.

FIG. 7 is a block diagram showing the components of an entertainment system “HNAS” that is advantageously configured to include the packet data handling provisions of the invention.

FIG. 8 is a diagram showing the adding of header offsets that can apply when protocols having distinct offsets are concatenated, and the manner in which a packet address is determined in view of the offsets.

FIG. 9 is a logic diagram showing the cascading of content addressable memory elements according to a preferred arrangement.

FIG. 10 is a data table diagram showing the layout of a local header that is applied to a data packet by operation of the invention.

### DETAILED DESCRIPTION OF PREFERRED EMBODIMENTS

Real Time Protocol or “RTP” provides end-to-end network transport functions suitable for applications transmitting real-time data, such as audio, video or simulation data, over multicast or unicast network services.

RTP does not address resource reservation and does not guarantee quality-of-service for real-time services, such as ensuring at the RTP protocol level that connections are maintained and packets are not lost, etc. The data transport protocol, namely RTP, is augmented by a control protocol (RTCP) that can be used for session control (namely RTP transfers from a source to a destination) and also an overall presentation control protocol (RTSP).

The RTCP and RTSP control protocols involve signaling packets that are transmitted, for example, when setting up or tearing down a transfer pathway, when initiating a transfer in one direction (PLAY) or the other direction (RECORD), when pausing and so forth. The content data packets need to stream insofar as possible continuously in real time with some synchronizing reference. The content packets are transmitted at the same time as the RTCP and RTSP packets but the packets of the three respective protocols use different addressed logical connections or sockets.

The RTCP/RTSP control and RTP data streaming protocols together provide tools that are scalable to large multicast networks. RTP and RTCP are designed to be independent of the underlying transport and network layers, and thus can be used with various alternative such layers. The protocol also supports the use of RTP-level translators and mixers, where desired.

The RTP control protocol (RTCP) has the capability to monitor the quality of service and to convey information about the participants in an on-going session. The participant information is sufficient for “loosely controlled” sessions, for example, where there is no explicit membership control and set-up, but a given application may have more demanding authorization or communication requirements, which is generally the ambit of the RTSP session control protocol.

RTP data content packets that are streamed between a source and destination are substantially simply passed along toward the destination address in real time. Whereas the packets are passing in real time, there is little need for buffering storage at the receiving apparatus. For the same reasons, the sending apparatus typically does not need to create temporary files. Unlike some other protocols, such as HTTP object transfer, RTP packetizes the object with media-specific headers. The RTP receiver is configured to recover from packet loss rather than having retry signaling capabilities. The RTP transfers can employ a TCP/IP connection-less protocol. Typically, RTP transfers are done with user datagram protocol (UDP) packet transfers of RTP data, typically but not necessarily with each UDP packet constituting one RTP packet.

An RTP packet has a fixed header identifying the packet as RTP, a packet sequence number, a timestamp, a synchronization source identification, a possibly empty list of contributing source identifiers, and payload data. The payload data contains a given count of data values, such as audio samples or compressed video data.

An aspect of a system that uses distinct real time data content packets (RTP) versus control (RTCP) and/or session control (RTSP) packets, is that all the three types or packets are sent and received over the same data pathway but are rather different in frequency and function. It is possible to provide a processor in a receiver, such as a network connected entertainment system, a video conferencing system, a network attached storage device or the like, and to program the processor to discriminate appropriately between RTP packets and RTCP or RTSP control packets. The data packets are passed toward their destination and the control packets are used by the processor to effect other programmed functions and transfers of information. For such a system to keep pace, the central processor must operate at a high data rate so as to pass the RTP data packets in real time. The processor also must have the computational complexity and programming needed to handle potentially involved control processes. The processor must be fast and capable, but the computational complexity of the processor is not used when simply passing RTP packets and the high data rate capacity of the processor is not necessary to handle control computations, which are infrequent by comparison.

An aspect of the present invention is to provide distinct data paths for the RTP data and the signaling data so that the computing power of the central processor (or processors) is not from handling routine passing of RTP data are free for special-case session processing, but generally are disassociated from the steady-state handling of RTP sessions. This partitioning is advantageous due to performance advantages that can be achieved by using hardware switching devices for data streaming and the central processor to deal with the complexity of multiple supported protocols at higher and/or lower application layers, such as different input and output protocols, devices, addresses and functions.

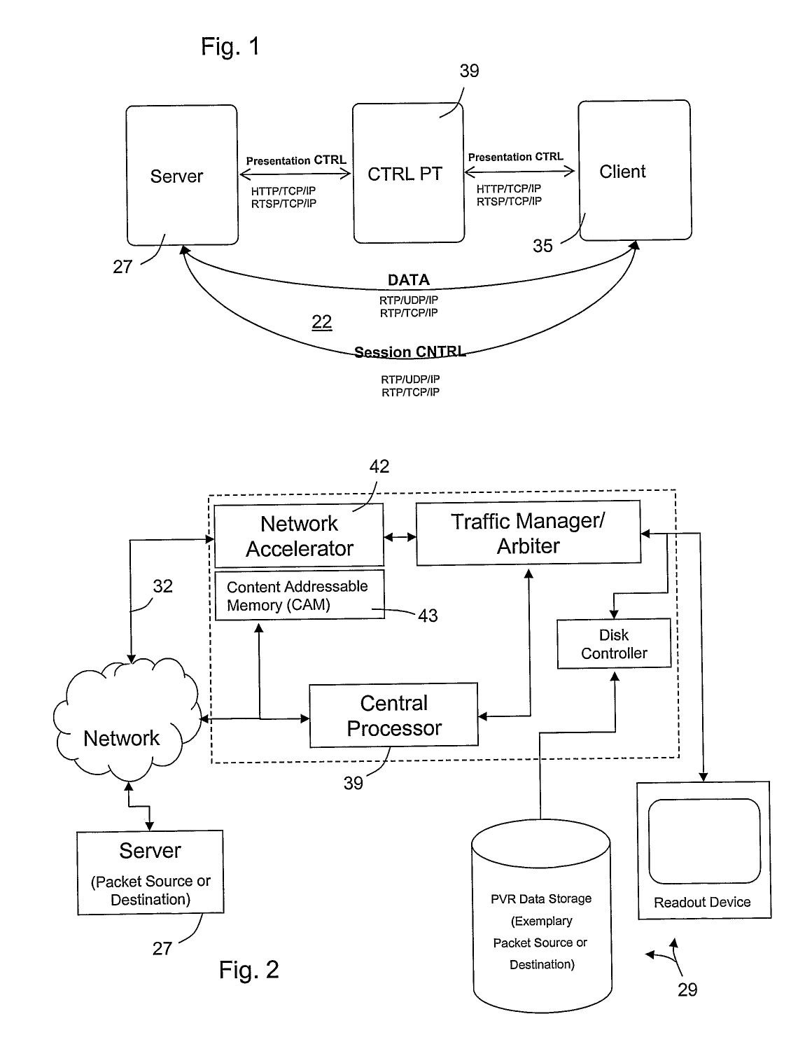

FIG. 1 shows a simple network environment with a control point disposed between a server (namely the source of the streaming data) and a client (the destination). Each interconnection is labeled with the various supported packet types for RTP streaming. The subject invention is broadly applicable to configurations involving a control point, and at least partly bypasses the need for processing at the control point, by providing a technique whereby fields in message headers are replaced using a hardware accelerator as described.

FIG. 2 shows an exemplary situation wherein the control point is represented by a central processor that is coupled to a packet source (shown as a server) over a network. In the configuration shown the central processor would conventionally be required to pass packets to one or more destinations, e.g., via a traffic manager/arbiter, by directing the packets identified in a stream of packets from the packet source to one or more addressable destinations, such as a network attached storage element, represented in this embodiment by disk memory and its controller, or to a readout device, etc.

According to an inventive aspect, the packet data is handled in the first instance by an interface device in the form of network accelerator. The network accelerator can be embodied as a high throughput device with minimal if any computational sophistication, configured to replaced header values in the incoming streamed RTP packets so as to control their handling. In particular, values are set into the content addressable memory of the network accelerator by the controller. The values, for example, can be a direct replacement of header values with local address values that route the packets to a storage device or readout or other local destination. Alternatively, the hardware accelerator can be directed by the controller to route the packets in some other way, such as directing two or more copies of the same content to two destinations, effectively splitting the signal path.

For this purpose, the content addressable memory of the hardware accelerator comprises a table that is loaded with a series of addresses, header values, flags or the like, which correspond to a particular stream when processing of the stream is initiated. As additional packets arrive in real time, the hardware accelerator accesses the corresponding information in the content addressable memory by locating the table entries for the associated stream and replace the header values in the packets with header values found in or generated from the values loaded in the content addressable memory. At least a subset of the values in the content addressable memory are values that originate in the control processor, for example to carry out user commands. A subset of the values in the content addressable memory optionally can be generated by operation of the hardware processor independent of the control processor. For example, the hardware processor can include a counter or adder that increments a sequence number or adjusts timestamp information under certain conditions, such as to recover from loss of a UDP packet or to effect smooth transitions during switching functions, etc.

The particular source and destination entities in this example are representative examples. The invention is applicable to situations involving a variety of potential sources and potential destinations that might be more or less proximal or distal and are coupled in data communication as shown, so as to function at a given time as the source or destination of packets passing in one or another or both directions between two such entities. This particular example might be arranged for the passage of packets in the situation where a content signal was to be shown on the playback device and recorded at the same time. In other examples, a data flow arrangement might be set up wherein data was recorded but not played back or played back but not recorded. Other particular source and destination elements could be involved. The same incoming packets could be routed from one source to two or more destinations. Alternatively, content from two or more sources could be designated for coordinated storage or playback, for example as a picture-in-picture inset or for simultaneous side by side display, for example when teleconferencing. These and other similar applications are readily possible according to the invention.

The data flows fall into three main types, namely RTSP packets for overall presentation control; RTCP packets for individual session control; and RTP packets for data content transfer.

RTSP is an application-layer protocol that is used to control one or many concurrent presentations or transfers of data. A single RTSP connection may control several RTP object transfers concurrently and/or consecutively. In a video conference arrangement, for example involving multiple locations, bidirectional transfers may be arranged between each pair of locations. The syntax of RTSP is similar to that of HTTP/1.1, but it provides conventions specific to media transfer. The major RTSP commands defining a session are:
SETUP: causes the server to allocate resources for a stream and start an RTSP session.
PLAY and RECORD: starts data transmission on a stream allocated via SETUP from a source to destination.
PAUSE: temporarily halts the stream without freeing server resources.
TEARDOWN: frees resources associated with the stream. The RTSP session ceases to exist on the server.

When the control point requests an object transfer using an RTSP SETUP request, it sends a request to the server and the client that includes the details of the object transfer, including the object identification, source and destination IP addresses and protocol ports, and the transport-level protocols (generally RTP, and either TCP or UDP) to be used. In this way, the RTSP requests describe the session to the client and server. In some cases the request can be specifically for a subset of an available object, such as an audio or video component of the object.

When all necessary SETUP requests have been made and acknowledged, the control point may issue a PLAY or RECORD request, depending on the direction of the transfer. The request may optionally designate a certain range of the object that is to be delivered, the normal play time of the object, and the local time at which the playback should begin.

Following the completion of playback, the presentation is automatically paused, as though a PAUSE command had been issued. When a PAUSE command is issued, it specifies the timestamp at which the stream should be paused, and the server (client) stops delivering data until a subsequent PLAY (RECORD) request is issued.

When a TEARDOWN request is issued, data delivery on the specified stream is halted, and all of the associated session resources are freed.

An RTSP command might specify an out-of-band transfer session wherein RTP/UDP or RTP/TCP is to be used for transport. An “out-of-band” transfer denotes two or more distinct transfer or connection paths. The RTSP traffic in that case can be over one connection, and a different connection can be specified by RTSP to carry the actual transport of RTP data.

RTP packets can be transported over TCP. This is generally inefficient because UDP transport does not require a maintained connection, is not sensitive to lost packets and/or does not try to detect and recover from lost packets, as does TCP. The UDP transport protocol is apt for transfer in real time of packets such as audio or video data sample values. Such values are not individually crucial but need to be moved in a high data volume. TCP is different from UDP in that connections are established, the protocol emphasizes reliability, e.g., seeking to recover from packet loss by obtaining retransmission, etc. These aspects are less consistent than UDP with the needs of RTP. This disclosure generally assumes that UDP will be used for RTP transmission. However the disclosure should not be considered as limited to the preferred UDP transport and instead encompasses TCP an other protocols as well.

When a server receives a request for an object to be delivered using RTP, the object typically is transcoded from its native format to a packetizable format. A number of “Request for Comment” (RFC) message threads have been developed in the industry to resolve issues associated with packetizing data as described and are maintained for online access, for example, by the Internet Engineering Task Force (ietf.org), including an associated RFC for various given media types.

Each media object type is typically packetized somewhat differently, even with varying header formats among types, according to the standardized specification provided in the associated RFC. The differences are due to the different objects and issues encountered in handling data having different uses.

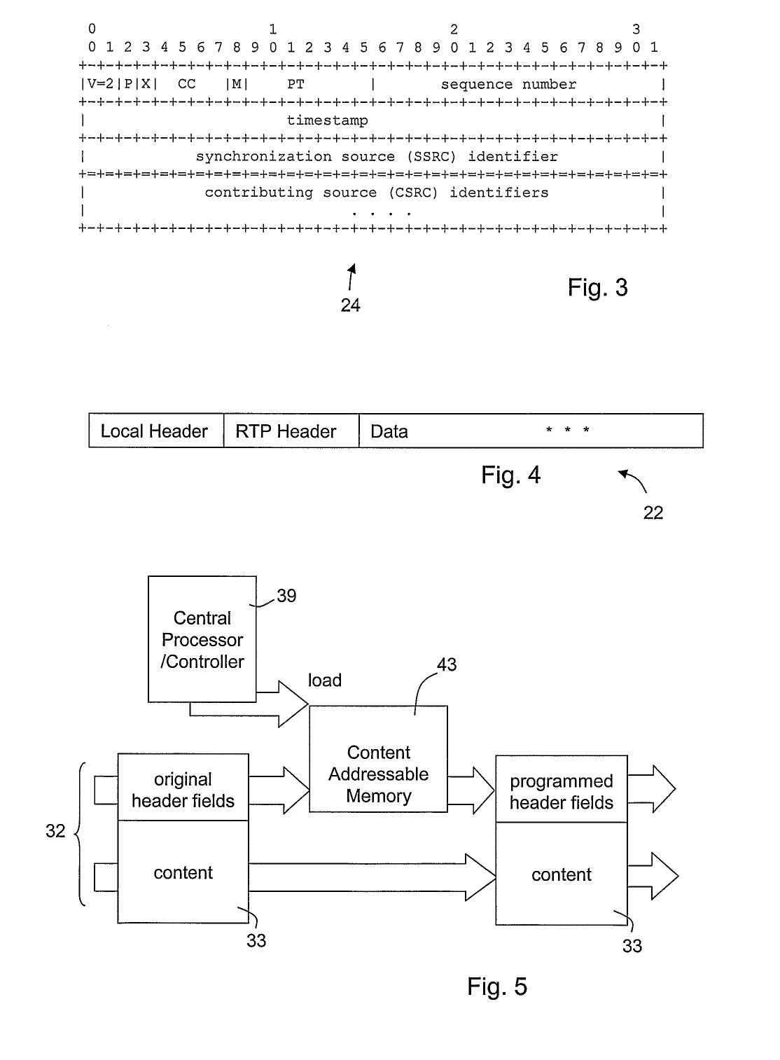

FIG. 3 shows the format of the common RTP header, for example as set forth in RFC 3550/3551. The header field abbreviations are as follows.

“V” represents the version number. The current version is version two. Although there is nothing inherent in the header that uniquely identifies the packet as being in RTP format, the appearance of the version number “2” at this header position is one indicator.

“P” is a value that indicates whether any padding exists at the end of the payload that should be ignored, and if so, the extent of padding. The last byte of the padding value gives the total number of padding bytes.

“X” is a value showing whether or not an extension header is present.

“CC” is a count of the number of contributing sources identified in this header.

“M” is a marker bit. The implementation of this bit is specific to the payload type.

“PT” identifies the payload type, namely the type of object being transported. Among other things, the payload type identifier allows the receiver to determine how to terminate the RTP stream.

“Sequence Number” is a count of the number of transferred RTP packets. It may be noted that this is unlike TCP, which uses a sequence number to indicate the number of transferred bytes. The RTP sequence number is the number of transferred RTP packets, i.e., a packet index.

“Timestamp” is a field value that depends on the payload type. Typically, the timestamp provides a time index for the packet being sent and in some instances provides a reference that allows the receiver to adapt to timing conditions in recording or playing back packet content.

“SSRC ID” identifies the source of the data being transferred.

“CSRC ID” identifies any contributing source or sources that have processed the data being transferred, such as mixers, translators, etc. There can be a plurality of contributing sources, or there may be none except the original source identified in SSRC ID. As noted above, the value CC in the header provides a count of contributing sources. The count allows the indefinite number of contributing source identifications to be treated as such, and to index forward to the content that follows the header.

If the X bit is set, there is an extension header that follows the RTP header. The use and nature of the extension header is payload-type-dependent. The payload-specific subheaders are generally specified in a way that allows packet loss to be ameliorated so as to be tolerable up to some frequency of occurrence. For some formats such as MPEG2, numerous complex subheaders with video and audio encoding information may follow the main RTP header.

The payload follows the last subheader in the packet shown in FIG. 3. The payload's relation to the native media object is also determined by the standard that describes the corresponding payload type. There is often not a one-to-one correspondence between the native object and the concatenation of RTP packet payloads. Although there are various factors that might contribute to this, some examples of situations underlying differences between the RTP packet payload sequences and the sequence of bytes contain in the native object might be due to:
a need to synchronize audio and video information for a given frame;
interleaving of data blocks within an RTP payload:
repeat packets for a crucial data element:
audio/video demuxing
or 1.1.3 RTCP

Periodically while a given RTP session is active, control information regarding the session is exchanged on a separate connection using RTCP (for UDP, the RTP session uses an even-numbered destination port and the RTCP information is transferred over the next higher odd-numbered destination port). RTCP performs various functions including providing feedback on the quality of the data distribution, which may be useful for a server to determine if network problems are local or global, especially in the case of IP multicast transfers. RTCP also functions to carry a persistent transport-level identifier for an RTP source, the CNAME. Since conflicts or program restarts may cause the migration of SSRC IDS, receivers require the CNAME to keep track of each participant. The CNAME may also be used to synchronize multiple related streams from various RTP sessions (e.g., to synchronize audio and video).

All participants in a transfer are required to send RTCP packets. The number of packets sent by each advantageously is scaled down when the number of participants in a session increases. By having each participant send its RTCP packets to all others, each participant can keep track of the number of participants. This number is in turn used to calculate the rate at which the control packets are sent. RTCP can be used to convey minimal session control information, such as participant information to be displayed in the user interface.

To accomplish these tasks, RTCP packets may fall into one of the following categories and formats:
SR:—sender report, for transmission and reception statistics from participants that are active senders;
RR:—receiver report, for reception statistics from participants that are not active senders and in combination with SR for active senders reporting on more than 31 sources;
SDES:—source description items, including CNAME;
BYE:—indicates end of participation; and,
PP:—application-specific functions.

Like RTP, each form of RTCP packet begins with a common header, followed by variable-length subheaders. Multiple RTCP packets can be concatenated to form a compound RTCP packet that may be sent together in a single packet of the lower-layer protocol.

It is an aspect of the invention to improve the implementation of a total RTSP/RTP solution by providing a hybrid hardware and software solution instead of providing a hardware-only solution or a software-only solution. Any all-hardware solution would have to be quite complicated if it would provide for all control situation scenarios. By contrast, any software-only solution having a processor and coding capable of dealing such complication would not be fully exploited. For most operations after a given stream is in process, many of the operations for continuing to handle successive packets for a given stream in the same manner as previous packet are handled using operations that are repetitive and do not require the computational power.

According to an advantageous embodiment of the invention, a hybrid solution is provided wherein the control process is largely set up and arranged by a controller operating a potentially complex and capable software program. However, specialized hardware is used to accelerate transfers using the media object and supporting files generated by software.

Due to their relative complexity and infrequency of operations, RTSP and RTCP functions, which are largely related to control steps, can be implemented in software on the central processor without overburdening it. RTP, on the other hand, requires processing of each incoming and outgoing packet in a media stream in sequence or near sequence with a real time data rate, and benefit according to the invention from hardware acceleration.

An example of operation is described herein for implementing a particular subset of streaming functionality, namely employing RTSP/RTP with hardware offloading of RTP content. This functionality is commonly found in Personal Video Recorders (PVR), and can be described as accepting an input stream of RTP-encapsulated data from an endpoint and either immediately or after an arbitrary period of time sending the same RTP-encapsulated data to either the same or a different endpoint. It is an attribute of such a function that the endpoints may be temporary and may change or be switched, e.g., according to user selections. The particular nature of the endpoints is not crucial to operation of the invention as described. The endpoints can be an originating or ultimate display device such as a video camera and a playback receiver, or an intermediate element such as a compression/decompression or format changing device, or any combination of these and other elements from which or to which a packet data signal may be directed in a stream.

As shown in FIG. 2, the media streamer comprises three main architectural entities, namely a central processor, a traffic manager/arbiter, and a network protocol or hardware accelerator. These structures may vary in their physical embodiment and may be more or less complex in terms of circuitry versus control processes. Inasmuch as the circuitry can be embodied in ways wherein the specific operational elements are more or less hard wired, certain functions of such elements are defined herein as they pertain to the handling of RTSP/RTP traffic according to the invention.

The central processor governs system processes. The network protocol accelerator or “hardware accelerator” handles resource-intensive but perhaps repetitive or iterative processing tasks. In this way, the hardware accelerator relieves the central processor of high-frequency low-complexity operations. Based on information provided in part by the incoming RTP packet header (shown in FIG. 3) and in part by values established by the controllers 39 when setting up a stream, a local header as shown in FIG. 4 can be pre-pended on the RTP header of a packet 22 (shown in FIG. 4). In this way the data flow proceeds as shown in the block diagram of FIG. 5, with the program-affected locally addressed header fields replaced using the content addressable memory, without the need to pass each packet through the controller 39.

The network hardware accelerator comprises a content-addressable memory (CAM) or table of values that are cross referenced in the memory, at least to those streams that are currently in progress. The content addressable memory stores connection parameters for hardware-accelerated connections, which include at least a subset of the connections that are possible using the apparatus as a whole. The hardware accelerator includes circuitry sufficient to determine whether an incoming packet is associated with a stream already established in the message queue information stored in the content addressable memory. If a message queue entry exists, the hardware accelerator handles the incoming packet in the manner already determined by the message queue entry. If packet does not have an existing entry, the hardware accelerator defers to the central processor to establish a new message queue entry if the packet is to become part of an accelerated stream. The manner of handling the packet can include replacing packet header values with local addresses, revising header values to cope with a particular situation, changing values associated with a different level of protocol, etc.

The traffic manager/arbiter is used to provide memory and disk access arbitration, as well as manage incoming and outgoing network traffic. It manages a number of queues that can be assigned for input and output of the various hardware accelerated connections and the central processor.

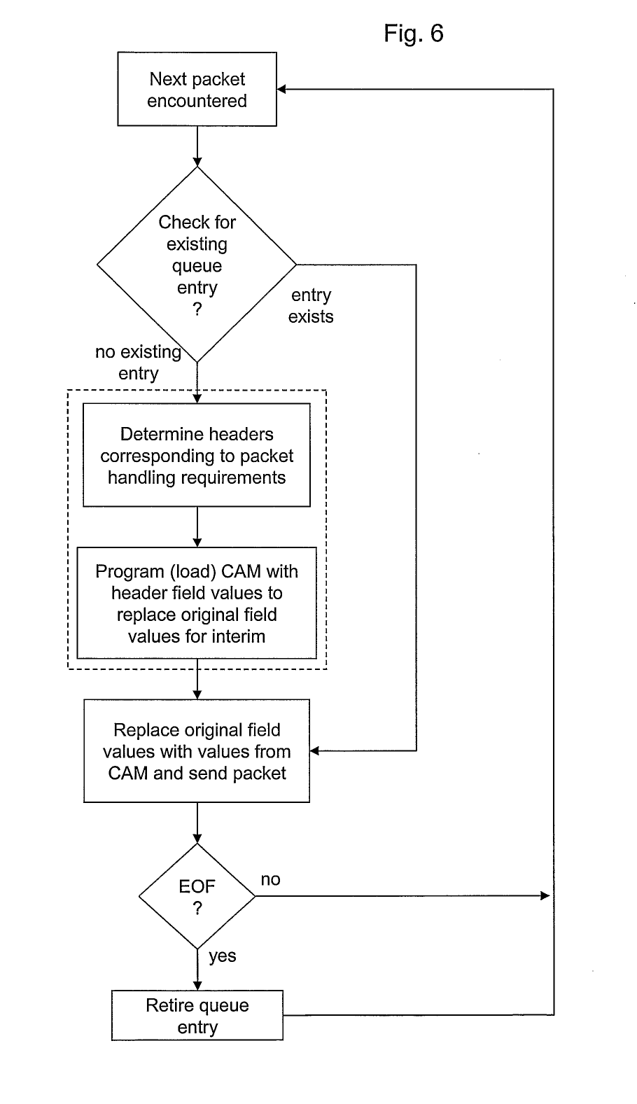

The method of the invention is illustrated in a data flow block diagram in FIG. 4 and in a flowchart in FIG. 6. The media streamer apparatus receives a stream of RTP packets from an endpoint, and must be implemented so as process the data with sufficient efficiency and speed to keep pace with the real time packet, and sufficient adaptive flexibility to be compatible with changes in requirements for data handling, such as invoking or shutting down new source/destination relationships with endpoints or with intermediate elements that may involve a wide array of dynamically varying RTP payload types, sources and destinations.

RTSP and RTCP operations are infrequent enough that they can be operatively implement in software running on the central processor, and the program executed can be complex, without typically causing problems with keeping pace with data content. Therefore, these functions preferably are implemented in the software running on the central processor.

RTP steady-state streaming, on the other hand, involves repetitive handling of packets, for example directing all the packets in a stream to a particular destination that can be temporarily assigned while a stream is active. The function is handled in the dedicated hardware of the network accelerator and the traffic manager/arbiter.

However, plural streams may be active at the same time. In order to handle packets for a given stream in a consistent way, the content addressable memory contains a set of values applicable to the stream, such as the destination address, last packet sequence number, etc. The hardware processor can contain a register that holds stream identification information referenced by way of the content addressable memory to the associated packet data values. By a comparison process (which can involve gating or a simple computation), the hardware accelerator matches the identification information on an incoming packet to an entry in the content addressable memory, and gates the information for the matched packet to an output. This process is used, for example, to replace data values in a packet header, such as the header address information, with local address information read out of the content addressable memory for the stream with which the packet is associated.

The replacement of values is a simple and repetitive process, shown generally by the flow chart of FIG. 6. If the next packet encountered in part of a current stream, it has a queue entry. The stream identification information (e.g., address information) is matched to an entry in the queue, namely in the content addressable memory. If not entry is found, the processor is signaled and an entry may be established by the processor, which is programmed for determining the appropriate queue entry values and storing them in the content addressable memory of the hardware accelerator (the processor functions are shown within a broken line box). During continued and further processing, the hardware accelerator determines the entries for the next packet received, replaces the original header values with values from the content addressable memory, and continues until an end of the stream, whereupon the queue entry in the content addressable memory for that stream is retired. The streaming apparatus is ready to support a new connection using the resources thereby freed.

The software processes carried on by the central processor include interfacing with the hardware elements through an Applications Program Interface (API) that can initiate, end and switch between particular operations, for example to handle user input choices. The API obscures the direct interface between the central processor and the hardware units (such as reading and writing registers, accessing hardware queues).

In a preferred example, the functionality of a personal video recording (PVR) apparatus can be implemented as follows, it being understood that this description concerns a nonlimiting example.

RTSP functions running in the programming of the central processor monitor for a SETUP command to be received from and endpoint that may be a source or destination of packet data. The packet(s) comprising an RTSP-SETUP request is (are) received by the network accelerator, and the stream identified therein does not match an entry in the CAM lookup table. The network accelerator assigns them to the appropriate traffic manager queue (which is the queue that is associated with incoming traffic for the central processor). Once the RTSP process receives a complete SETUP message, the CAM lookup parameters (source and destination IP addresses and ports, and transport protocol) are determined from the SETUP message (wholly or partly). A connection table entry in the CAM table is established for the RTP session.

RTSP then waits for a subsequent RECORD request from the associated endpoint. If (or when) an RTSP-RECORD message is received, it is passed from the network accelerator to the traffic manager to the central processor via the same path as the SETUP message. The RECORD message may contain a (time) range of the stream to record. At this point the session can be considered established and the network accelerator is ready to receive data. The central processor sends an object size based on the range (if range is not specified, the maximum value is sent) and an available queue identification QID is submitted to the traffic manager for scheduling. This enables the hardware accelerator to process the packets by a simple replacement of header values for so long as the stream lasts without changes.

Changes can be made by terminating or modifying the CAM table entry, for example if a local storage device is to commence recording of an incoming stream, and entry directing that stream to a playback device can be modified so that packets also are directed to the disk controller. Alternatively, another entry can be added that associates the stream with an endpoint at the local storage device.

The RTP termination routines, switching operations that may vary according to conditions and similar computationally intensive functions may be too complex to be performed in relatively simple hardware. The time pressure of streaming data packets in real time likewise are too strict to allow a central processor with an extensive program efficiently to handle the incoming traffic in a timely manner at all time (i.e., on-the-fly). The invention implements an alternate method wherein each packet on the stream is received by the network accelerator, which matches the packet in the connection table, strips the layer three and four headers, applies a local header, and sends each packet with local header, RTP header, and RTP payload to the traffic manager for writing to the destination, such as the local disk.

The format of the incoming packet is such that the Local Header comprises a 32-bit quantity that included a value for the total length of the packet and any required flags. These fields define the boundaries of each RTP packet and remain useful after the packet has been stored to the disk. While the object is stored in this format, the stored packets can be scheduled for delivery back to the originating endpoint in an acknowledgement, or can be routed to another endpoint on the network. The traffic manager must have the ability to read the object, packet-by-packet, such that it can extract the Length field for each packet from the Local Header to use as the transfer size. The traffic manager sends Length bytes of data to the network accelerator and advances the queue to the start of the next packet.

When a packet is received from the traffic manager, the network accelerator strips off the local header, and adds an offset. The offset is determined initially by the central processor, and is stored as a field in the content addressable memory (CAM) table for the associated transfer, to contribute to determining the Sequence Number field to be placed in the outgoing packet RTP header by the hardware accelerator. This enables the provision of a random ISS, as specified in RFC 3550.

The outgoing timestamp is adjusted in a comparable way. This enables provision of a random ITS, as specified in RFC 3550.

The layer three and layer four headers are similarly constructed and placed in the header of the outgoing packet. The outgoing packet is sent to the MAC/PHY block.

One advantage of this method is that incoming RTP traffic can be managed by software. As various different RTP payload types come into use or perhaps change in definition, support for them can be maintained by the inventive streaming apparatus. In addition, PVR functionality of delayed-view-while-recording can be supported.

A disadvantage is that while the object is stored in the RTP-header format, it is not accessible for HTTP transfers. Software on the host central processor can be used to reassemble the original media object in order to make the object available, immediately to non-RTP clients, or to any clients by reassembly deferred until the necessary resources are available.

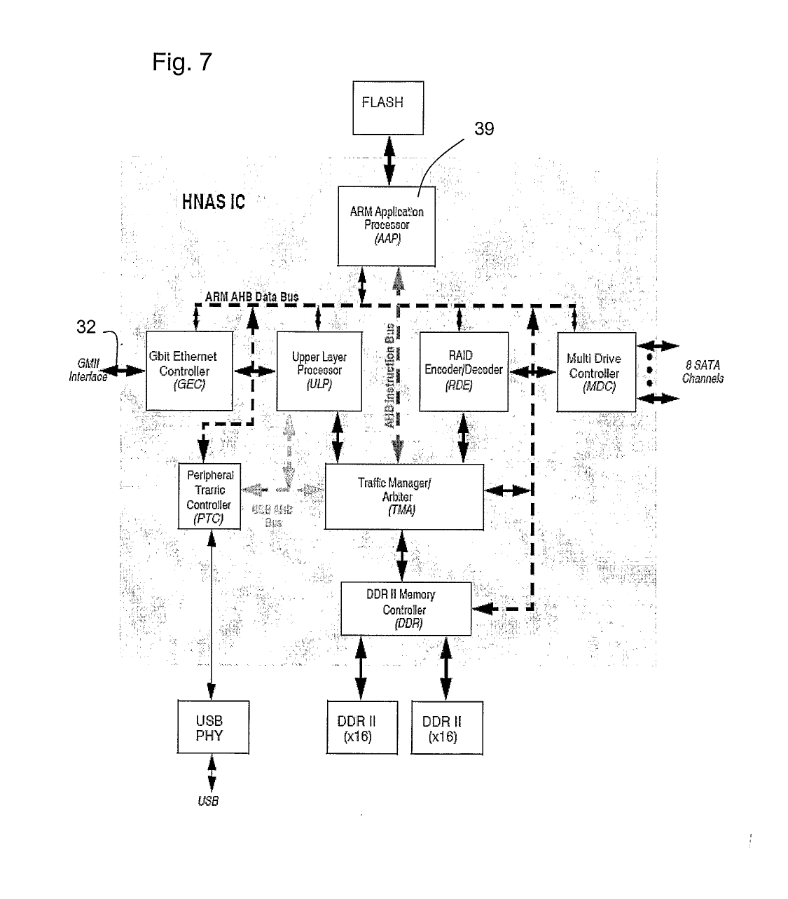

Referring to FIG. 7, in an advantageous embodiment, the invention is incorporated into a data manipulating system including a disk array controller device. This device can performs storage management and serving for consumer electronics digital media applications, or other applications with similar characteristics, such as communications and teleconferencing. In an entertainment application, the device provides an interface between a home network and an array of data storage devices, generally exemplified by hard disk drives (HDDs) for storing digital media (audio, video, images).

The device preferably provides an integrated 10/100/1000 Ethernet MAC port for interfacing toward a home network or other local area network (LAN). A USB 2.0 peripheral attachment port is advantageously provided for connectivity of media input devices (such as flash cards) or connectivity to a wireless home network through the addition of an external wireless LAN adapter.

The preferred data manipulating system employs a number of layers and functions for high-performance shared access to the media archive, through an upper layer protocol acceleration engine (for IP/TCP, IP/UDP processing) and a session-aware traffic manager. The session aware traffic manager operates as the central processor that in addition to managing RTP streaming as discussed herein, enables allocation of shared resources such as network bandwidth, memory bandwidth, and disk-array bandwidth according to the type of active media session. For example, a video session receives more resources than an image browsing session. Moreover, the bandwidth is allocated as guaranteed bandwidth for time-sensitive media sessions or as best-effort bandwidth for non time sensitive applications, such as media archive bulk upload or multi-PC backup applications.

The data manipulating system includes high-performance streaming with an associated redundant array of independent disks (RAID). The streaming-RAID block can be arranged for error-protective redundancy and protects the media stored on the archive against the failure of any single HDD. The HDDs can be serial ATA (SATA) disks, with the system, for example including eight SATA disks and a capacity to handle up to 64 simultaneous bidirectional streams through a traffic manager/arbiter block.

Inasmuch as the data manipulating systems is an example of various possible applications for the invention, the overall data manipulating system is shown in FIG. 7 and described only generally. There are two separate data paths within the device, namely the receive path and the transmit path. The “receive” path is considered the direction by which traffic flows from other external devices to the system, and the “transmit” path is the opposite direction of data flow, which paths lead at some point from a source and toward a destination, respectively, in the context of a given stream.

The Upper Layer Processor (ULP) is coupled in data communication to/from either a Gigabit Ethernet Controller (GEC) or the Peripheral Traffic Controller (PTC). The PTC interfaces directly to the Traffic Manager/Arbiter (TMA) for non packet based transfers. Packet transfers are handled as discussed herein.

In the receive data path, either the GEC or PTC block typically receives Ethernet packets from a physical interface, e.g., a to/from a larger network. The GEC performs various Ethernet protocol related checking, including packet integrity, multicast address filtering etc. The packets are passed to the ULP block for further processing.

The ULP parses the Layer 2, 3 and 4 header fields that are extracted to form an address. A connection lookup is then performed based on the address. Using the lookup result the ULP makes a decision as to where to send the received packet. An arrival packet from an already established connection is tagged with a pre-defined Queue ID (QID) for traffic queuing purpose used by TMA. A packet from an unknown connection requires further investigation by and application processor (MP). The packet is tagged with a special QID and routed to MP. The final destination of an arrival packet after AAP will be either the hard disks for storage when it carries media content or the AAP for further investigation when it carries a control message or the packet can not be recognized by AAP, potentially leading to the establishment of a new Queue ID. In any of the above conditions, the packet is sent to TMA block.

TMA stores the arriving traffic in the shared memory. In the case of media object transfers, the incoming object data is stored in memory, and transferred to a RAID Decoder and Encoder (RDE) block for disk storage. TMA manages the storage process by providing the appropriate control information to the RDE. The control traffic destined for AAP inspection are stored in the shared memory as well, and the MP is given access to read the packets in memory. The AAP also uses this mechanism to re-order any of the packets received in out-of-order. A part of the shared memory and disk contains program instructions and data for the MP. The TMA manages the access to the memory and disk by transferring control information from the disk to memory and memory to disk. The TMA also enables the AAP to insert data and extract data to and from an existing packet stream.

In the transmit data path, TMA manages the object retrieval requests from the disk that are destined to be processed as necessary to send via the Application Processor or the network interface. Upon receiving a media playback request from the Application Processor, the TMA receives the data transferred from the disks through MDC and RDE blocks and stores it in memory. The TMA then schedules the data to ULP block according to required bandwidth and media type. The ULP encapsulates the data with the Ethernet and L3/L4 headers for each outgoing packet. The packets are then sent to either GEC or PTC block based on the destination port specified.

For incoming packets on the receive data path, a connection lookup functional part of the network accelerator can include address forming, CAM table lookup, and connection table lookup functional blocks. The CAM lookup address is formed in part as a result of information extracted from the incoming packet header. The particulars of the header field to be extracted depend on the traffic protocol in use. The to-be-formed address has to represent a unique connection. For most popular internet traffic, for example carried in IP V4 and TCP/UDP protocol, the source IP address, destination IP address, TCP/UDP source port number, TCP/UDP destination port number and protocol type (the so called “five tuple” from packet header) define a unique connection. Other fields may be used to determine a connection if a packet is of different traffic protocol (such as IP V6). Appropriate controls such as flags and identifying codes can be referenced where multiple protocols are served, so as to make the system a “protocol aware” hierarchical one. For example, the process can be divided into three stages, with each stage corresponding to a level of protocol supported. A first stage can check the version number of L3 protocol from a field extracted during the header parsing process and stored in an information buffer entry for an arriving packet as a step in the address forming process. For second and third stages in the address forming process, a composite hardware table is provided. The table entry number at each stage depends on the stage the table is in and the number of different protocols to be supported at each stage. Each table entry always consists of a content addressable memory (CAM) entry and a position number register. Each position register is always composed of a pair of offset-size fields. Each CAM entry stores the specific protocol values for the corresponding position register. The offset specifies the number of bytes to be skipped from the beginning of packet header to the field to be extracted. The size field specifies the number of nibbles to be extracted. The same address is used to access both the CAM field and the position register.

It is possible that the header length at a particular protocol level is not fixed. For example, TCP and IP header lengths may change due to “option” fields. A potentially variable header length from the outer level protocol would relatively displace field positions at the inner level protocol, including the inner level header length itself. In order to accommodate varying header lengths, a protocol header length field can be extracted as part of the address lookup process for those levels that include a length field. It is also possible that some protocols (such as IP V6 and UDP) don't have length fields in the header. In that case, no header length can be extracted, but it is possible by other techniques can be employed, such as setting and keeping a fixed header length during a given connection.

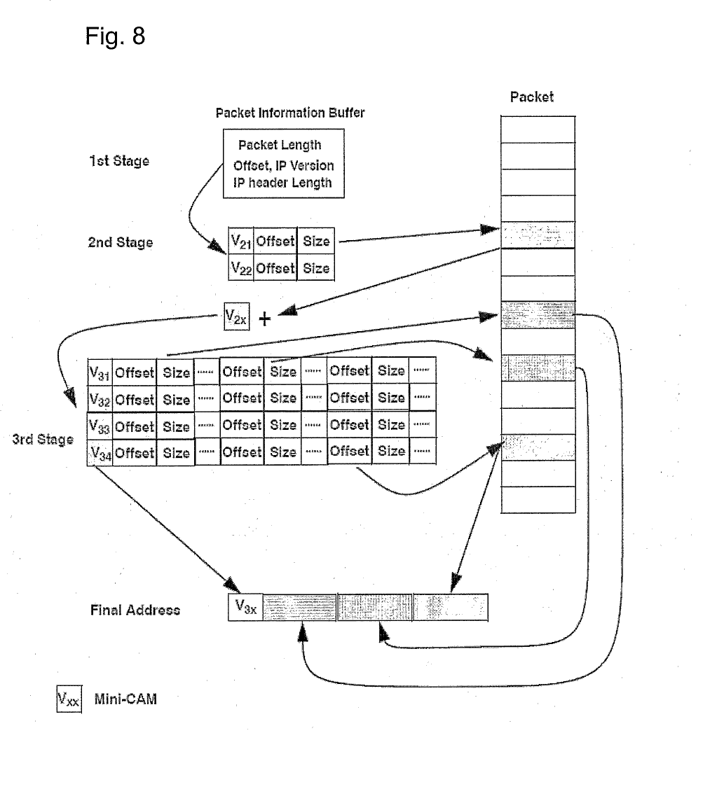

The address forming process is shown graphically in FIG. 8. During the address forming process, a packet is buffered and the first level of protocol (e.g. version number for IP protocol) is identified and stored in a packet information table. There are many entries in the packet information table at a given time, and the entry at the head of packet information buffer is accessed first. The header length (e.g., the IP header length) is extracted from the packet information table if the length entry exists. The protocol type code extracted from the first stage affects where to find second stage protocol values.

The CAM supports any possible combination of protocols and offsets. The first offset-size value determined leads the extraction of the second level of protocol (e.g., the protocol field for IP protocol in this example). The position number register entries correspond one for one with the number of CAM entries at each stage. There are two pairs of position registers for each entry in the second stage. The header length field (e.g., the IP header length), if it exists, is extracted from the packet header according to the offset specified in the second pair of position registers.

The field extracting process at third stage is similar to that of second stage. However, the CAM access at the third stage must reflect the concatenation of protocol types extracted from both first and second stages, etc. There are now eight pairs of offset-size fields for extracting values from eight fields. The multiple fields extracted from each entry, in view of the protocol type value, are used to identify the entry such that values are concatenated together to form a final address.

The fields accessed in the buffer or address forming registers and the content addressable memory are handled by the network accelerator. The control processor at the ULP only reads the value necessary to construct a lookup address for determining the address of required valued in the CAM. If there is a CAM lookup miss during the address forming process, the process can be aborted and the incoming packet is tagged with an error flag.

It is possible if the protocol fields extracted at each stage have different lengths for different protocols, to pad the entry to obtain a fixed offset size. Unused bits pad memory addresses up to the fixed size in order to enable a fixed length CAM lookup.

The dimensions of the address forming register can be summarized. The second stage has two register entries, two CAM entries, and one pair of position registers for each message queue entry. The third stage has eight register entries, eight CAM entries and eight pairs of position registers. Each position register comprises 16 bits, with 10 bits to represent offset (to cover 512 bytes), 6 bits for size (to represent 64 nibbles).

The value formed in address forming section is used together with the information previously stored by the control processor (namely the application processor) when a connection was established, namely upon arrival of packets that signaled the initiation of a connection for transport of particular data between particular source and destination points. The control processor populates the content addressable memory (CAM) with entries. Each entry in the CAM uniquely determines a connection.

When the system is initialized (i.e., before any transport connections have been established, there is no entry in the CAM. Therefore, when a first packet arrives, no matching addressing entry will be found the to match address information in the CAM, and the packet will tentatively be regarded as a CAM lookup miss. In that case, a special Queue ID (QID) is assigned to the packet at a memory position that is reserved for the control processor (namely application processor AAP).

The AAP may determine a need to setup a connection upon analyzing the arrival packet. A free entry is found in the CAM (e.g., one of 64 possible streams that the system can support simultaneously). The free entry address is used to set up the connection table for the new stream. The AAP writes the connection address into the free entry of the CAM so that later arrival packets with the same address will match the entry in the CAM. This permits the later arriving packets to be handled without requiring the attention of the AAP, because the packets are handled by the network accelerator function discussed.

When an arriving packet is found to match an existing connection having an entry in the CAM (a CAM hit), the address of the matching CAM entry is used to lookup the connection table information, the QID and other information. In the example under discussion, there are 64 CAM entries to support 64 connections. Each CAM entry is allocated up to 256 bits. Of course other specific counts are possible.

Both the occupied CAM entries and the free CAM entries can be accessible to the control processor AAP. The control processor AAP is responsible for setting up, tearing down and recycling CAM entries.

The CAM device itself can be embodied in various ways that generally comprise registers and gating arrangements that enable at least a subset of potential input data values to be used as addressing inputs to extract from the memory a corresponding output data value. Random access memory devices typically store and retrieve data by addressing specific memory locations, each possible input value corresponding to a memory location. A large number of addressing bits correspond to a large number of memory locations, and where the number of memory entries is not large, the time required to find a given entry in memory can be reduced by hardware gating arrangements enabling a digital comparison with a portion of the stored data content in the memory, itself rather than by specifying a memory address. Memory that is accessed in this way is called content-addressable memory (CAM) and has an advantage in an application of the type discussed.

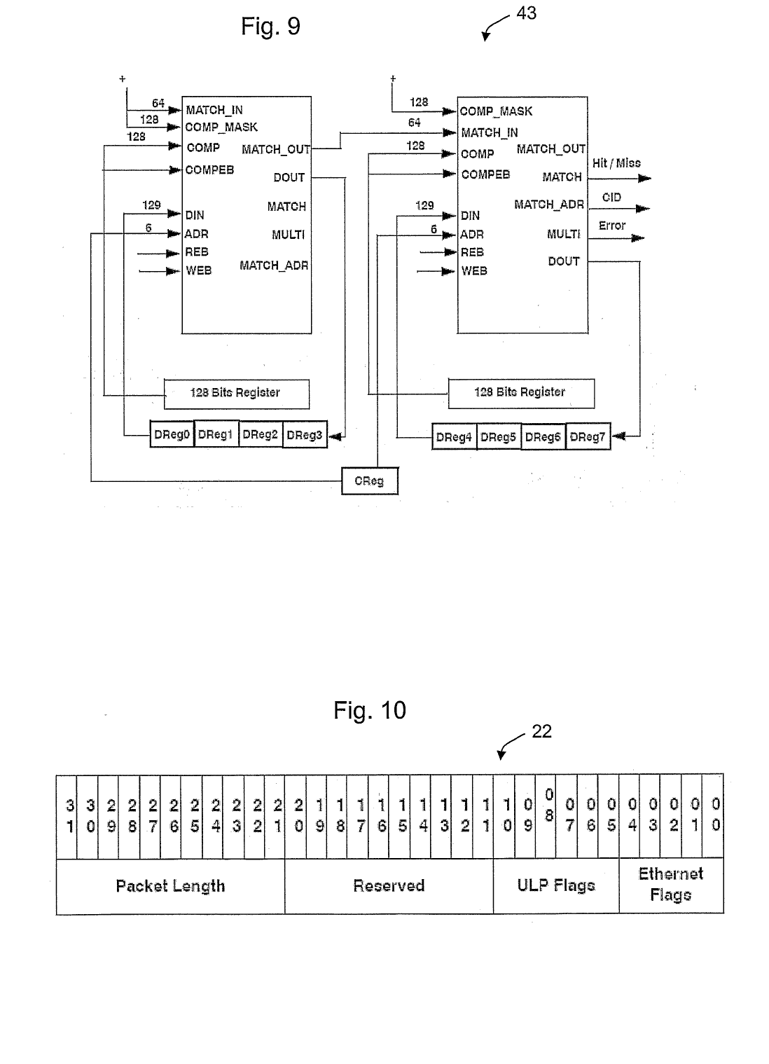

In the example under discussion, the CAM can vary in the width of stored values from 4 to 144 bits, and has a depth from 6 to 1024 entries. In one embodiment, shown in FIG. 9, two concatenated CAM devices are provided, each comprising a 64 entry by 129 bits device, for supporting up to 64 bidirectional streams. Of the 129 bits, 128 bits are used for data storage, 1 bit is used as an entry-valid bit. This arrangement, forming a 64 by 256 CAM, is represented in FIG. 9 as a simplified CAM lookup logic diagram, where a 256 bit word is split into two 128 bits sub words, and each sub word is compared against the content of a separate CAM device. In this arrangement, it is possible that one or another of the 128 bit sub words matches multiple entries in each CAM device. However the entire 256 bit entry can only correspond to a unique stored value. This operation is facilitated by coordinated addressing and cascading the comparisons of the two CAM devices.

When there is a CAM hit for an arrival packet, the CAM address of the entry which matches the arrival address is used to access various information values concerning the connection. These are outlined in the following Table I.

TABLE I

| | Size | |
|---|---|---|
| Name of Field | (bits) | Description |
| QID | 6 | Queue ID used for traffic management |
| | | when there is no lookup problem |
| Header_Keep | 1 | Header Keep Bit indicates if ULP should |
| | | strip off L2, L3 and L4 header when |
| | | sending the packet to TMA. Note that this |
| | | bit only applies when QID is used. When |
| | | Error_QID is used, the header is always |
| | | kept. |
| OOS_QID | 6 | Out of Sequence Queue ID: This QID is |
| | | used for out of sequence packets, etc. |
| Local Header Enable | 1 | When set, ULP will pre-pend a local |
| | | header to each arrival packet |

For some connections, a local header is generated and pre-pended to each incoming packet. Such local header generation is configurable by the MP. A ULP local header is created when a packet arrives from network. The local header has a fixed size of 32 bits with a format specified in FIG. 10. The ULP pre-pends the packet length derived by counting each receiving packet byte. In addition, it also embed the flags created by the Gigabit Ethernet Controller and by itself from lookup into the local header. The ULP adds the local header with the same format as long as local header is enabled regardless of packet destination.

The invention is exemplified by an apparatus, but is also considered an inventive method. With reference to the drawing figures, the inventive streaming apparatus (see FIGS. 1, 2, 7) directs data packets 22 having fields 24 representing at least one of a control value, a source address, a destination address and a payload type, between a source 27 and a destination 29. A communication pathway 32 receives the data packets from a server 27 or the like, and at least a content portion 33 of the data packets 22 is passed to at least one client 35, according to rules determined from said fields of the data packets 22.

The rules include alternatives by which the data packets might be passed to one or more clients in distinct ways, such as being addressed to different specific devices, processed through different protocol handling specifics, etc. A control processor 39 is coupled to the communications pathway. The functions of the control processor can be provided wholly or partly in one or more of an upper layer processor (ULP) and application processor (MP) or in an additional controller. In any event, the control processor at least partly determines procedures applicable to the at least two alternatives for processing the packets when establishing a connection or stream.

According to an inventive aspect, a network accelerator 42 having a memory 43 is coupled to the control processor 39, which loads the memory 43 of the network accelerator with data representing the at least two alternative procedures by which the data packets are passed in distinct ways. The procedures include (but are not limited to) directing the packets to distinct local or remote addresses. The network accelerator 42 thereafter is operable substantially independently of the controller 39 to pass the data packets 22 to the client 35. The data packets 22 have headers 24 (FIG. 3) containing the fields and the network accelerator 42 is operable responsive to the fields for at least one of replacing and appending said fields to select between the at least two alternatives.

The apparatus is apt for handling RTP real time protocol streaming. In addition to packets containing program content such as data samples or compressed data programming in RTP, the data packets further comprise control information according to one of RTSP and RTCP streaming control protocols.

In the preferred arrangements, the network accelerator contains a content addressable memory having data values that are used, for example, for local addressing, of each ongoing stream while active. The controller sets up the data values that are to be used for a given stream. Using the content addressable memory, at least some of the same data values are used for subsequent packets of the same stream, without tapping substantially into the computational resources of the controller, while exploiting the high data rate that is possible using the hardware accelerator containing or at least coupled to the content addressable memory.

The respective components are operated to effect a method comprising the steps of packetizing content with associated header information representing at least one variable by which packetized content is selectably handled between one or more sources and one or more destinations therefor as a function of said variable; including control information in the streaming content, whereby a manner of selectably handling the packetized content is variable according to the control information; establishing or redirecting, pausing or otherwise altering a stream of the packetized content between a source and destination, and when so doing, determining a value the variable at least partly from the control information and storing said value in the network accelerator in association with an identification of the stream. Thereafter, when receiving packetized content for the stream, the value stored in the network accelerator in association with the identification of the stream, is used in handling the received packetized content.

Accordingly, the packetized content of the ongoing stream is selectably handled in large part by the network accelerator, with minimal ongoing action from the control processor.

The invention has been disclosed in connection with a exemplary embodiments but reference should be made to the appended claims rather than the discussion of examples to determine the scope of the invention in which exclusive rights are claimed.

1. A streaming apparatus for directing data packets having fields representing at least one of a control value, a source address, a destination address and a payload type, the apparatus comprising:
a communication pathway for receiving the data packets from a server and along which pathway at least a content portion of the data packets is passed to at least one client, according to procedures determined in part from said fields of the data packets;
wherein the procedures include at least two alternatives by which said data packets can be passed to the at least one client in at least two distinct ways;
a control processor coupled to the communication pathway, wherein the control processor is operable at least partly to determine one of said procedures to be applied to the respective alternatives;
a network accelerator having a memory, wherein the control processor is operable to load the memory of the network accelerator with data representing the at least two alternatives by which the data packets are passed in distinct ways, and wherein the network accelerator thereafter is operable substantially independently of the control processor to pass the data packets to the at least one client in said distinct ways according to the procedures therefor.

2. The streaming apparatus of claim 1, wherein the data packets have headers containing said fields and the network accelerator is operable responsive to the fields for at least one of replacing and appending said fields to select between the at least two alternatives.

3. The streaming apparatus according to claim 1, wherein the data packets are passed to the at least one client in distinct ways including by altering addressing information associated with the packets.

4. The streaming apparatus according to claim 3, wherein the data packets are appended with local addresses to which the data packets are to be passed according to the rules.

5. The streaming apparatus of claim 1, wherein the data packets comprise content packets configured according to RTP streaming protocol and contain addressing information, and wherein the content packets are provided by the network accelerator with one of supplemental and substitute addressing information.

6. The streaming apparatus of claim 5, wherein the data packets further comprise control information according to one of RTSP and RTCP streaming control protocols.

7. The streaming apparatus of claim 6, wherein information in at least certain of said data packets comprising control information according to said one of RTSP and RTCP steaming control protocols is employed according to programming of the control processor to define the rules by which the content packets are passed to the at least one client.

8. The streaming apparatus of claim 7, wherein the network accelerator comprises a content addressable memory device loaded by the control processor with information defining said rules, and wherein the network accelerator accesses a given rule that is applicable to a given packet by reading from the memory device data stored according to the programming of the control processor.

9. The streaming apparatus of claim 8, wherein the data packets represent at least one of audio data and video data, and wherein the rules apply to distinct switched processes of one of an audio or video storage device, an entertainment apparatus, an audio communication facility and a teleconferencing facility.

10. The streaming apparatus of claim 9, wherein the network accelerator is operable according to the rules to direct the packets to a destination device and to a network storage apparatus.

11. The streaming apparatus of claim 9, wherein the network accelerator is operable according to the rules to direct the packets to a destination device comprising a readout device, a storage device, an intermediate data processor for transforming the packets, a local terminal device, and a remote terminal device.

12. A method for streaming content substantially in pace with a real time reference of the content, comprising:
packetizing the content with associated header information representing at least one variable by which packetized content is selectably handled between one or more sources and one or more destinations therefor as a function of said variable;
including control information in the streaming content, whereby a manner of selectably handling the packetized content is variable according to the control information;
providing a control processor with access to the control information and a network accelerator with access to the packetized content;
upon one of establishing, redirecting, pausing and otherwise altering a stream of the packetized content between at least one said source and at least one said destination, determining a value the variable at least partly from the control information and storing said value in the network accelerator in association with an identification of the stream;
upon receiving packetized content for the stream, determining from the network accelerator the value stored in association with the identification of the stream, and handling the received packetized content between said one or more sources and said one or more destinations based on said value as determined from the network accelerator, whereby the packetized content of an ongoing stream is selectably handled with minimal ongoing action from the control processor.

13. The method of claim 12, further comprising revising the value stored in the network accelerator, said revising being accomplished by operation of the control processor.

14. The method of claim 13, wherein the control processor revised the value stored in the network accelerator as a result of processing of subsequently received control information.

15. The method of claim 12, comprising providing a plurality of identified streams having entries in the hardware accelerator, and wherein the hardware accelerator selectively applies to increments of the packetized content one of plural values stored in the hardware accelerator in association with a corresponding identified stream.

16. The method of claim 15, comprising providing a content addressable memory containing a message queue wherein the entries for the identified streams are accessible, and determining said one of the plural values by matching an entry with an identification of a corresponding one of the identified streams.
